(19) United States
(12) Patent Application Publication
(10) Pub. No.: US 2004/0020323 A1
(43) Pub. Date: Feb. 5, 2004

(54) Adjustable pedal system

(76) Inventors: Ralf Harth, Darmstadt (DE); Jurgen Schonlau, Walluf (DE); Steffen Linkenbach, Eschborn (DE)

Correspondence Address: RATNERPRESTIA, P O BOX 980, VALLEY FORGE, PA, 19482-0980, US

(21) Appl. No.: 10/311,190

(22) PCT Filed: Jun. 13, 2001
(86) PCT No.: PCT/EP01/06665

(30) Foreign Application Priority Data
Jun. 14, 2000 (DE) 10028591.0

(51) Int. Cl. G05G 1/14

(52) U.S. Cl. 74/512

(57) ABSTRACT

The present invention relates to a pedal assembly or pedal system, comprising one or more pedals (1) whose neutral position can be adjusted. When the pedal lever acts by way of an actuating rod (7) of a control element (6) that is firmly linked with the vehicle, the readjustment of the neutral position of the pedal lever (12) simultaneously effects a readjustment of the actuator (actuating rod (7) itself. The adjustment of the neutral position of the pedal thus results in an actuation of the control element, which is not desired. An object of the present invention is to provide a pedal system such that the readjustment of the neutral position of the pedal(s) does not cause an actuation of the actuator. This object is achieved by the present invention in that the pedal or the pedals, respectively, is/are pivotally mounted on a carrier, said carrier (3) being pivoted about a first axis (E) which coincides with the point of application (A) of the actuating rod (7) of the control element (6) on the pedal lever (12).

The present invention relates to a pedal system for motor vehicles by which the mode of operation of individual vehicle components is controllable. It is often desired to easily adapt a vehicle to different drivers. Thus, there exist e.g. different adjustments of the back mirror that can be made with a counter. As soon as a driver adjusts the count predetermined for him/her, the single mirrors are moved to adopt the position predetermined for the specific driver. Because of the different heights of individual drivers, there have already been proposals to adapt the individual pedals in their position to the respective vehicle operator. EP-OS 918273 e.g. discloses a pedal assembly wherein the pedals suspended on a support member may pivot along with the support member. A disadvantage of the clutch pedal described therein is that the actuating cylinder of the clutch pivots together with the support member. It is, however, not possible in many cases to pivot a control element of this type together with the support member because it, is necessary to anchor said control element in a stationary fashion on the vehicle.

DE-OS 2941345 discloses another adjustable pedal assembly. In this arrangement, two pedal levers arranged on a support member are pivoted jointly with the support member. In addition, the support member may be displaced along with the two pedals on a straight line in relation to the attachment of the support member. In this case, too, a control element for controlling the brake is attached to the support member itself and pivots jointly with the pedals. Likewise this construction is not appropriate to ensure fixation of the control element in relation to the vehicle chassis.

In view of the above, the present invention is based on a pedal assembly of the type to be taken from the preamble of claim 1, and its objective is to ensure that the readjustment out of the neutral position of the pedals can be done largely without effect on the control element.

This object is achieved by the combination of features to be taken from the characterizing portion of claim 1. Thus, the present invention on principle involves arranging the point of application of the actuating rod on the pedal lever in a defined geometric allocation to the pivot axis of the support member. The said allocation is basically chosen so that the position of the point of application will change only to a very small degree or will not change at all when the support member is pivoted in the holder. If, for example, the support member pivots about a defined angle, the pedal or pedals will simultaneously pivot as this occurs. When the support member rotates about an axis that extends through the point of application, admittedly, the angular position of the pedal lever with respect to the actuator will change. However, the relative positioning of pedal and points of application will be maintained in all other respects.

When the support member pivots only a small extent, it may be sufficient to implement the features of claim 2. This applies in particular if the operating point is only a small radial distance away from the pivot axis of the support member or this point lies on the axis itself.

A particularly expedient embodiment of the present invention is achieved by the combination of features according to claim 3. The adjustable pedal is the brake pedal in this arrangement.

According to a favorable aspect of the invention as claimed in claim 4, the control element may be the actuating rod of a valve, of a master cylinder, or of a vacuum booster. As mentioned above, the present invention is especially suitable when it is implemented on a brake system for motor vehicles, meaning that the pedal lever is used as lever for the brake pedal. In this arrangement, the control element can be arranged in a holder on the vehicle. However, the present invention also discloses mounting the control element directly on the chassis of the vehicle.

Only one single pedal lever may be provided in the present invention. Yet this invention is also very well suited to pivot several pedals simultaneously which are jointly arranged in the pivotal support member.

The pedals can be pivoted mechanically by the driver adapting the neutral normal position of the pedals to his/her height, which is done by pivoting the support member. This pivot action may also be effected automatically by an electric drive, with the driver predefining a determined readjustment and the electric drive then pivoting the support member about a determined angle in response thereto. The electric drive may be a motor driving a threaded spindle having its end remote from the motor connected to the support member.

The present invention will be described in the following by way of an embodiment. In the embodiment,

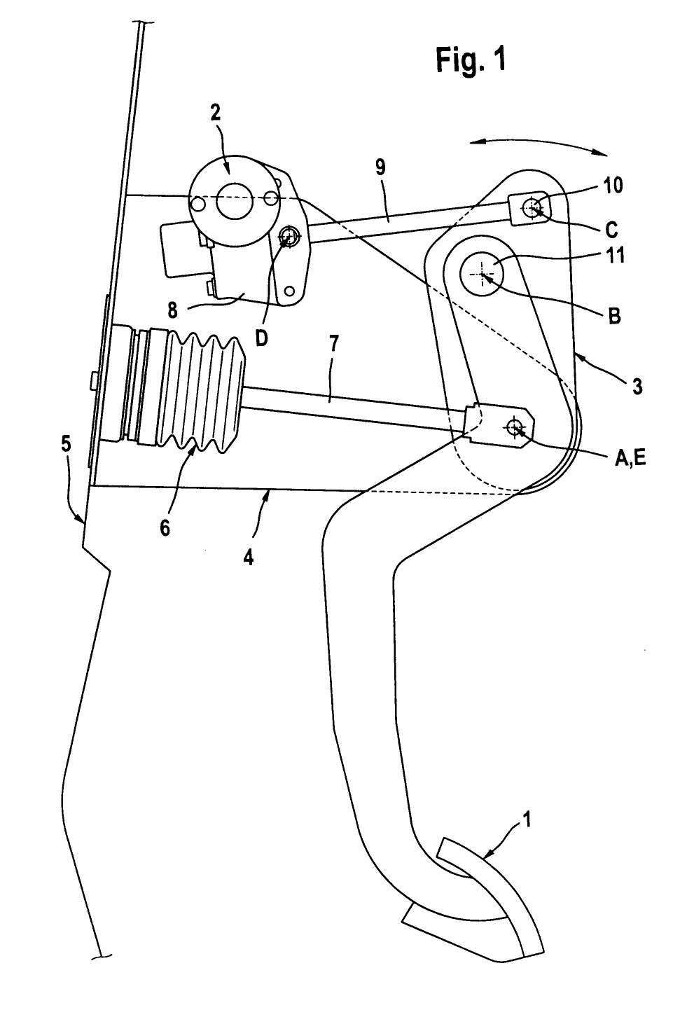

FIG. 1 is a side view and a representation of the embodiment of the present invention.

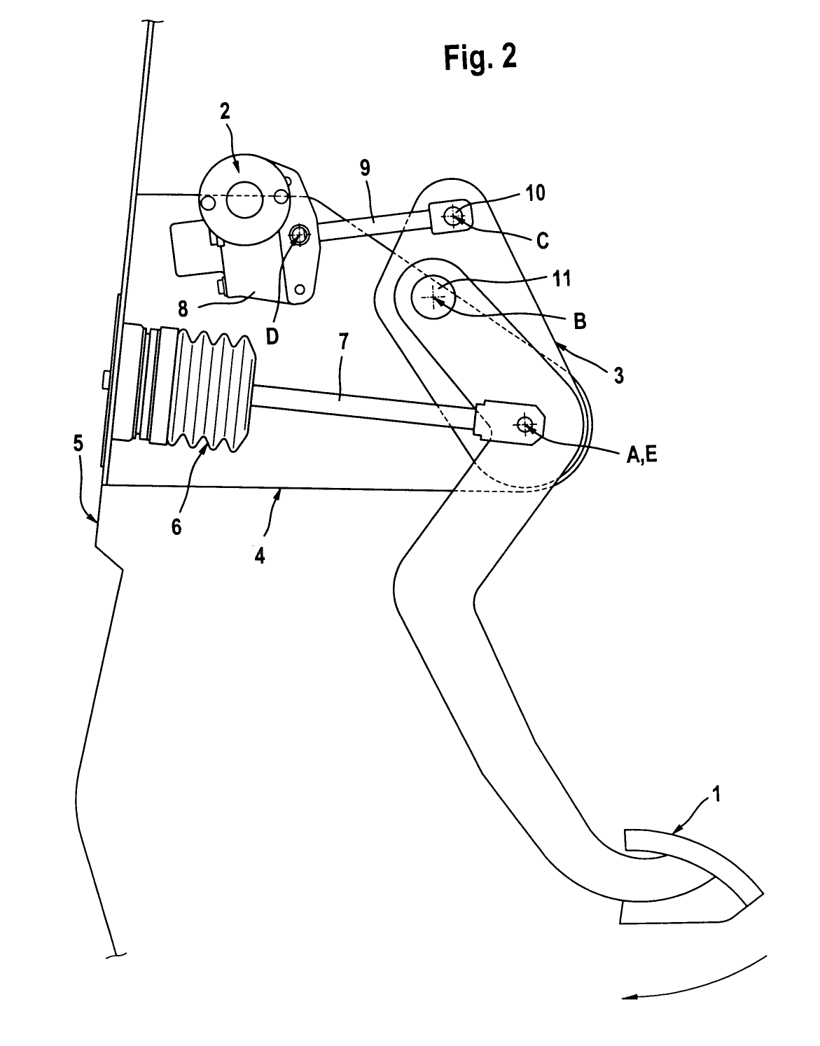

FIG. 2 shows the embodiment of FIG. 1 with a modified position of pedals.

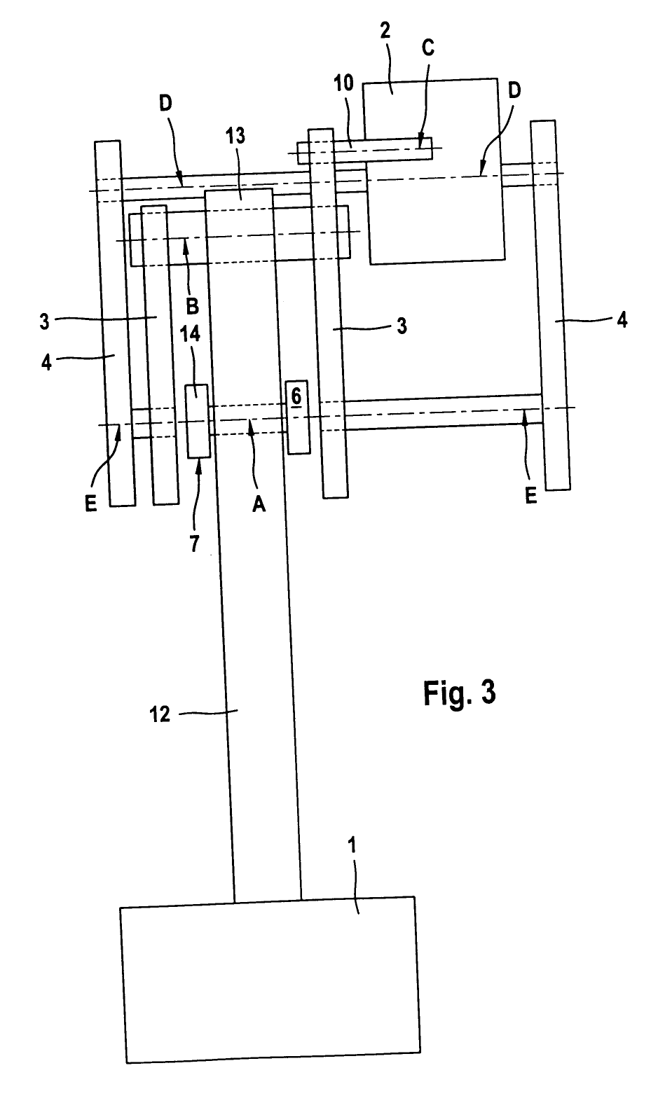

FIG. 3 is a representation of a front view of this invention with individual pivot axes offset to each other in parallel.

FIG. 1 shows a splashboard 5 in the bottom portion of the passenger compartment of a vehicle, not shown in detail. A hydraulic or pneumatic booster 6, in the capacity of a control element as indicated in FIG. 1, is attached to splashboard 5. The booster may also be arranged behind the splashboard and, hence, exterior of the passenger compartment. In this case, the actuating rod 7 of the booster 6 projects through the splashboard 5, then actuating the booster disposed behind the splashboard. As shown in FIG. 1, a holder 4 is fastened to splashboard 5, said holder comprising two parallel metal sheets (shown in detail in FIG. 4) that extend perpendicularly from the splashboard. Holder 4, being this way fixed on the splashboard, carries a driving motor 2.

Connected to the driving motor 2 is a gear 8 and a driving spindle 9. Driving spindle 9 with its end remote from gear 8 makes catch at a carrier 3. As becomes apparent from FIG. 3, the carrier 3 is generally comprised of two rigidly interconnected parallel metal sheets which, in turn, are aligned in parallel to the two metal sheets of the holder 4. The carrier 3 is pivotally mounted in the holder 4, with carrier 3 being pivotal relative to holder 4 about the axis E. When the motor 2 drives the driving spindle 9, the point of application C is moved along the longitudinal axis of the spindle, with the carrier 3 being turned about the pivot axis E. FIG. 3 indicates a driving pin 10 that is connected to the end (not shown) of the driving spindle remote from the motor and couples the carrier 3 to the spindle end.

FIG. 3 shows that the top end 13 of the pedal lever 12 is pivotally mounted in the carrier 3 by means of a cross bolt 11. The rotation occurs about the axis B, as can be taken from

FIG. 1. As shown in FIGS. 1 and 3 the pedal lever 12 in addition is supported on the free end of the actuating rod 7 of the booster 6 at the level of axis A. The angular position of the pedal lever 12 in the neutral condition is thus predefined by the relative position of the two axes of rotation B and A.

When now e.g. the carrier 3 in FIG. 1 and, hence, the axis B in FIG. 1 pivots counterclockwise to the left, pedal 1 will also pivot about the axis A or E, respectively, in the counterclockwise direction to the right and, thus, in the direction of the driver's feet. On account of the fact that the pivot axis B is positioned very far at the top and the pivot lever 12 is relatively long, pedal 1 covers already quite a long distance at a small angle.

It is especially important for the present invention that the position of axis A is not displaced in parallel as the carrier is pivoted about axis E. This means that the pivot movement of the carrier and, thus, of the pedal lever has no influence on the position of the point of application A of the actuating rod 7 at the pedal lever 12 (which remains on the axis A) and, consequently, does not cause readjustment or movement of the free end of the actuating rod 7. It is thereby achieved that the pedal lever 12 can be pivoted without the position of the end of actuating rod 7 changing, although the booster 6 is rigidly connected to the splashboard by way of holder 4.

The present invention is not limited to the embodiment of the individual circuit components illustrated in detail in the Figures. Rather, the principle is important of positioning the point of application A of the actuating rod 7 in the extension of the axis of rotation E of the carrier 3 in the holder 4. Thus, it is e.g. possible to present the carrier 3 and the holder 4 by one single metal sheet respectively. Using a fork 14 at the open end of the actuating rod 7 may be omitted under certain circumstances in FIG. 3, provided that it is ensured that the actuating rod 7 with its open end makes catch at the level of the axis of rotation A. The mentioned point of application A of the actuating rod 7 at the pedal lever 12 should not be considered as a single geometrical point. It is important that the force of the pedal lever 12 is exerted proximate the axis of rotation E of the carrier 3 in holder 4. This prevents that the point of application A describes a circle as the carrier 3 is pivoting, which is likely to cause a force exerted on the actuating rod 7, either hindering the pivot movement of the carrier or damaging the actuating rod 7 in its capacity as actuator or the booster 6 in its capacity as control element. Further, the measure described permits the pivot movement of the pedal lever 12 to adapt to the pivot movement of the carrier as the pedal system is readjusted, with the pivot movement roughly exhibiting the same course as if the pedal lever 12 were connected to the carrier in points A and E. The result is the great advantage that the brake pedal on readjustment covers the same distance as the other pedals arranged in parallel to the same carrier. Consequently, the pedals maintain the same position relative to each other, what does not impair their actuation.

Therefore, the layout of the present invention may be described briefly as follows: A pedal system for use on a vehicle is concerned where the positions of the pedals are adjustable with respect to the driver. In this readjustment, the points of articulation of the pedals are displaced relative to the pedal stand or the splashboard, respectively, in such a fashion that the points of articulation for the booster, accelerator pedal and clutch remain the same. Shafts and gearwheels may be used for the transmission of motion from an actuator (motor) to the pedals. The holder 4 is attached to the splashboard or the vehicle body. The carrier 3 is mounted in holder 4 pivotal about axis E. The drive 2 is mounted in holder 4 pivotal about axis D. Axis C allows the readjustment of the carrier 3. The axis A is the point of articulation of the actuation 6 at the brake pedal 1. The axis of rotation E for the readjustment of the carrier 3 with respect to the holder 4 is disposed on a line for the articulation A of the actuation 6 at the brake pedal. The brake pedal is mounted in carrier 3 pivotal about the axis B. The brake pedal turns about the axis B when the brake is applied (picture 2). When the position of the pedals with respect to the driver is changed, the carrier 3 will turn about the axis E, actuated by the drive 2 in relation to the holder 4 or the splashboard, respectively (FIG. 3). The rotation induces the movement of the axis of rotation B as well as of all pedals, the accelerator pedal sensor and the brake light switch. The point of articulation A for the actuation 6 remains in its position without change.

1. Adjustable pedal system for a vehicle with a holder (4) fixed to the vehicle body (5), wherein in the holder (4) a carrier (3) is mounted pivotally about a first axis (E), wherein at least one pedal lever (12) is arranged at the carrier (3) pivotal about a second axis (B), and wherein the pedal lever (12) on its actuation acts upon an actuator (7) by pivoting about the second axis (B) by way of a thus pivoted point of application (A) and, as this occurs, the point of application (A) displaces by a displacement travel, characterized in that the displacement travel is generally disposed in a plane defined by the first axis (E).

2. Pedal system as claimed in claim 1, characterized in that the point of application (A) of the pedal lever (12) in relation to the actuator (7), in the inactive condition of the control element (6) actuated by the actuator (7), generally lies in the area of the extension of the first axis (E).

3. Pedal system as claimed in any one of claims 1 or 2, characterized in that the pedal lever (12) acts upon a brake, preferably the hydraulic brake of a motor vehicle.

4. Pedal system as claimed in any one of claims 1 to 3, characterized in that the actuator (7) is the actuating rod of a valve, master cylinder or vacuum booster (6).

5. Pedal system as claimed in any one of claims 1 to 4, characterized in that the holder (4) is attached to the splashboard (5) of the vehicle.

6. Pedal system as claimed in any one of claims 1 to 5, characterized in that several pedal levers (12) are arranged pivotally about the second axis (B) on the carrier (3).

7. Pedal system as claimed in any one of claims 1 to 6, characterized in that the carrier (3) is pivoted by means of an electric drive (2), with an electric motor equipped with a gear being preferably fixed in a rotatable manner on the holder (4) in the capacity of a drive.
